(19) United States
(12) Patent Application Publication
(10) Pub. No.: US 2019/0389613 A1
(43) Pub. Date: Dec. 26, 2019

(54) METHOD FOR PROCESSING HEAT TRANSFER LABELS

(71) Applicant: AVERY DENNISON RETAIL INFORMATION SERVICES, LLC, Mentor, OH (US)

(72) Inventor: Michael Colarossi, Sudbury, MA (US)

(21) Appl. No.: 16/448,421

(22) Filed: Jun. 21, 2019

Related U.S. Application Data
(60) Provisional application No. 62/688,554, filed on Jun. 22, 2018.

(51) Int. Cl. B65C 9/18; B65C 5/04; D06P 5/24

(52) U.S. Cl. CPC B65C 9/1873; D06P 5/003; B65C 9/1823; B65C 5/04

(57) ABSTRACT

A method for processing heat transfer labels for quality assurance purposes that may be provided in the form of a roll, with defective heat transfer labels remaining included within the roll instead of being removed. A marking system may be used during or after production of the heat transfer labels in order to distinguish acceptable heat transfer labels from defective heat transfer labels to prevent the latter from being used in the manufacture of garments or other goods. A sensor eye may be disposed on the heat bonder used in the production process to detect the marks and automatically advance the roll to the next acceptable heat transfer label.

### CROSS REFERENCE TO RELATED APPLICATION(S)

The present application claims priority from and the benefit of United States provisional utility patent Application No. 62/688,554 filed Jun. 22, 2018, which is incorporated by herein by reference in its entirety.

### FIELD OF THE INVENTION

The present invention is in the field of heat transfer labels. More particularly, the present invention relates generally to a quality assessment processing heat transfer labels to distinguish between defective and non-defective heat transfer labels during production and prior to application of a defective heat transfer label to an article.

### BACKGROUND OF THE INVENTION

Heat transfer labels (HTLs) often resemble decal-like labels and may be applied to a variety of articles through the application of heat or via a cold transfer process. They are commonly applied to garments like shirts or sportswear, or similar articles such as shoes, but may also be applied to other articles such as product packaging. In many cases, heat transfer labels may be printed and prepared in small quantities, or even as custom single-unit prints for individual customers, so that a customer or a small set of customers can customize their own garments. However, much larger production runs may be contemplated for a variety of reasons. In one example, there may be instances in which garment manufacturers or article manufacturers wish to apply heat transfers to articles as they are being manufactured. For example, a manufacturer of sports memorabilia may wish to manufacture a large supply of sports jerseys with the lettering and/or number of a famous athlete. In another example, it may be desired to print and prepare a large variety of simple labels that many customers may want to use to customize their own articles, such as letters or numbers that a customer may wish to apply as appropriate in order to spell out their own name on an article.

Often, when manufactured in large quantities, heat transfer labels are provided on a single sheet of carrier film, which often is polyethylene terephthalate (PET or PETE). If the labels are then used in the production of a garment or other article, each sheet of PET is placed over the garment and a heat bonder is used in order to affix the heat transfer label to the garment via heat and pressure. The step is then repeated as necessary until the order is completed.

Numerous defects may occur, however, due to defects in materials and/or equipment. Some examples of defects include poor edge definition of printed labels, label smearing, and variations in width or length of printed labels, which may be caused by the ribbon moving too rapidly through the printer over at least a portion of the print. Other problems can include streaks, dead spots, or ribbon wrinkles, usually caused by the ribbon becoming misaligned in the manufacturing equipment. Numerous other problems are possible.

Defective heat transfer labels can be easily identified by proper quality assurance procedures. Such defects are usually quite obvious from visual inspection. Existing manufacturing procedures usually remove defective heat transfer labels prior to shipping, so that they are not used in the making of goods. Such procedures have certain downsides. For example, in some instances, heat transfer labels many be manufactured in the form of a roll, or along a continuous strip of single-sheet carrier film. In such a case, removal of defective heat transfer labels may require that the continuous strip of film be severed in order to remove the bad label. This means that heat transfer label rolls may come in inconsistent sizes, assuming that the manufacturing process has a noticeable error rate, which will make the subsequent manufacturing of goods using heat transfer labels more complicated and less efficient. Alternatively, each individual heat transfer label may be cut out from the roll in order to remove defective heat transfer labels. While this will result in production of a consistent product, it will also introduce additional manufacturing complications and inefficiencies.

Accordingly, there is a need for a heat transfer label manufacturing and processing method and system capable of addressing the above drawbacks of current processes. In particular, there is a need for heat transfer label manufacturing and processing methods and systems that are capable of identifying defective heat transfer labels and advancing such labels through a processing system without causing protracted disruptions to standard processing or manufacturing steps.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

According to certain aspects of the present disclosure, a process for speeding up the assembly of garments or other goods onto which a heat transfer label may be applied is disclosed. In some embodiments, heat transfer labels may be manufactured in a roll-to-roll format, in such a manner that a mark is applied on or next to each defective label. Garments may then be manufactured using the heat transfer labels, in such a manner that the applicator skips any defective labels that have been marked in order to move on to the next label on the roll. Subsequent defective labels are skipped as necessary until the applicator advances to an acceptable heat transfer label. Advantageously, this process may speed up the manufacturing of heat transfer labels and/or the assembly of article such as garments utilizing heat transfer labels. Because a higher manufacturing speed may result in a higher error rate such as, by resulting in a greater number of defective heat transfer labels, embodiments disclosed herein may make a higher error rate more acceptable or at least easier to accommodate during production processes.

According to some embodiments, a mark to be applied to a heat transfer label ribbon may include, for example, an ink mark or other physical mark, such as a stamp, punch, or cut in the ribbon, or any other type of mark such as may be desired. In one embodiment, a mark may be applied over the heat transfer label, such as a large “X” or a punch applied to the heat transfer label. In some embodiments, such a mark may create an indentation in the heat transfer label, which may be used to directly indicate it as a defective product.

According to some embodiments, a label bonder may be provided with one or more sensors, such as one or more optical, light, proximity, and/or infrared (IR) sensors, which may be used in order to detect a mark or may be used to detect the presence of a defective label. In some embodiments, the one or more sensors may be any other kind of sensor, such as a laser or mechanical sensor configured to detect a punched-out portion of the ribbon or web and indicate that a corresponding heat transfer label is defective. For example, according to an exemplary embodiment in which a mark is applied over a heat transfer label itself, a sensor may be configured to point directly at the label, such that a mark can be detected and any visible defects can also be detected.

According to some embodiments, a method of processing heat transfer labels comprises providing a carrier sheet comprising at least one heat transfer label contained in a heat transfer label area, the heat transfer label area comprising at least one mark space, determining if the at least one heat transfer label is defective, and marking the at least one heat transfer label if defective. In some embodiments, the carrier sheet is provided in a roll-to-roll format, for example, as a roll, and the at least one heat transfer label comprises a plurality of heat transfer labels. In some embodiments, determining it the at least one heat transfer label is defective comprises scanning the at least one heat transfer label with a sensor.

In some embodiments, the method of processing heat transfer labels further comprises performing quality assurance procedures. In some embodiments, the method of processing heat transfer labels further comprises identifying a defective heat transfer label with a sensor. In some embodiments, the method of processing heat transfer labels further comprises automatically advancing a carrier sheet roll from a defective heat transfer label to a later heat transfer label. In some embodiments, the step of automatically advancing the roll occurs if a sensor identifies a mark on the defective heat transfer label.

According to some embodiments, a system for processing heat transfer labels comprises a carrier sheet comprising at least one heat transfer label contained in a heat transfer label area, the heat transfer label area comprising at least one mark space, a first sensor, a marking tool, and a second sensor. In some embodiments, the first sensor is configured to scan the at least one heat transfer label during manufacturing to determine if the at least one heat transfer label is defective. In some embodiments, the second sensor is an optical sensor configured to identify defective heat transfer labels, and in some embodiments, the optical sensor is configured to identify a mark made on a defective heat transfer label. In some embodiments, the carrier sheet is in a roll-to-roll format, in a roll for example, and the at least one heat transfer label comprises a plurality of heat transfer labels. In some embodiments, the second sensor is configured to automatically advance the carrier sheet roll from a defective heat transfer label to a later heat transfer label. In some embodiments, the second sensor is configured to automatically advance the carrier sheet roll if the second sensor identifies a mark on the defective heat transfer label.

According to some embodiments, the system for processing heat transfer labels comprises one or both of a visual device for user feedback and an audio device for user feedback. In some embodiments, the heat transfer label area has a plurality of mark spaces, and in some embodiments, each of the plurality of heat transfer labels has a corresponding mark space.

According to other embodiments of the present disclosure, a sensor station apparatus comprises a heat bonder comprising a sensor system, at least one roller, and a marking tool. In some embodiments, the sensor system comprises a sensor configured to scan heat transfer labels provided on a carrier web and determine if any heat transfer labels are defective. In some embodiments, the sensor is configured to advance the carrier web from a defective heat transfer label to a later heat transfer label. In some embodiments, the sensor is at least one of an optical, light, proximity, and/or infrared sensor. In some embodiments, the sensor station apparatus comprises one or both of a visual device for user feedback and an audio device for user feedback.

Other features and advantages of the present invention will become apparent to those skilled in the art from the following detailed description. It is to be understood, however, that the detailed description of the various embodiments and specific examples, while indicating preferred and other embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

Advantages of embodiments of the present invention will be apparent from the following detailed description of the exemplary embodiments thereof, which description should be considered in conjunction with the accompanying drawings in which like numerals indicate like elements, in which:

FIG. 1 is an embodiment of a set of heat transfer labels provided on a carrier film according to certain aspects of the present disclosure;

FIG. 2 is an embodiment of a set of heat transfer labels provided on a carrier film according to certain aspects of the present disclosure;

FIG. 3 is an embodiment of a set of heat transfer labels provided on a carrier film according to certain aspects of the present disclosure;

FIG. 4 is an embodiment of a sensor station according to certain aspects of the present disclosure;

FIG. 5 is an embodiment of a sensor station according to certain aspects of the present disclosure;

FIG. 6 is an embodiment of a sensor station according to certain aspects of the present disclosure; and

FIG. 7 is a flowchart depicting an exemplary embodiment of a method of continuous processing of heat transfer labels according to certain aspects of the present disclosure.

### DETAILED DESCRIPTION OF THE INVENTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

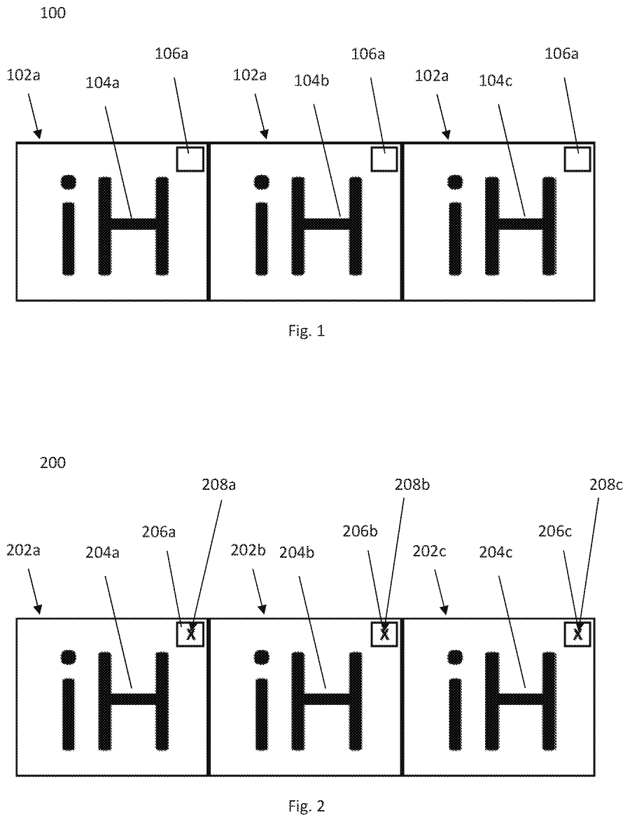

According to some embodiments, and referring generally to FIGS. 1-3, various exemplary implementations of a set of heat transfer labels on a sheet or film may be disclosed. In some embodiments, one or more heat transfer labels may be provided on a carrier sheet or carrier film. It is also contemplated, the carrier sheet, such as a web or roll, may be any sort of polymer known in the art such as, but not limited to PET or any sort recycled PET. The present invention contemplates that the carrier sheet can be a paper. In certain manufacturing practices, the carrier sheet is placed over an object such as, but not limited to, a clothing garment, and a bonder, such as a heat bonder, may be used in order to affix the heat transfer label to the object. In some embodiments, a bonder affixes a heat transfer label to a garment via heat and pressure. This step may then be repeated as necessary or desired to affix multiple heat transfer labels to the same garment, or to affix one or more heat transfer labels to different garments.

FIG. 1 depicts an exemplary embodiment of a carrier sheet, such as a label web 100, including a set of heat transfer labels 104a, 104b, 104c. FIG. 1 illustrates a label web 100 having at least three distinct heat transfer labels 104a, 104b, 104c, each contained in a distinct heat transfer label area 102a, 102b, 102c, although any number of distinct heat transfer labels 104 or heat transfer label areas 102 can be used. For example, a much higher, or even a lower, number than three heat transfer labels 104 and heat transfer label areas 102 may be produced in the typical production run. For ease of depiction, however, label web 100 is shown having only three heat transfer labels 104 in three heat transfer label areas 102.

Each heat transfer label area 102a, 102b, 102c, comprises at least one heat transfer label 104a, 104b, 104c and at least one mark space 106a, 106b, 106c. Though shown in the top-right of the heat transfer label area 102, the at least one mark space 106 may be positioned at any location within heat transfer label area 102. In some embodiments, the at least one mark space 106 is positioned in a central area of heat transfer label area 102. In other embodiments, the at least one mark space 106 is positioned around a perimeter of heat transfer label area 102, for example adjacent to an edge of heat transfer label area 102. In still further embodiments, the at least one mark space 106 is positioned in any corner of the heat transfer label area 102. In some embodiments, a plurality of heat transfer labels 104 and/or mark spaces 106 may be positioned anywhere within the perimeter of a heat transfer label area 102

During a production run of heat transfer labels 104, one or more of the heat transfer labels 104 may be defective. As discussed herein, such defects may result from any number of a variety of reasons. For example, a heat transfer label 104 may be applied in the wrong place or otherwise misaligned, may be smeared, may be too large or too small, or may have any other problems that may stem from typical manufacturing practices. Thus, according to some embodiments presently contemplated, one or more heat transfer labels 104 may be examined for defects during a production run by a sensor system (and optionally subject to manual oversight), so that defective heat transfer labels may be marked either manually or systematically.

In some embodiments, a mark may be provided in a mark space 106 corresponding to a defective heat transfer label 104. In some exemplary embodiments, the mark space 106 may be applied to the heat transfer label area 102 in the shape of a box, as illustrated in FIG. 1. However, other geometric shapes or figures may be assigned as the mark space 106.

In some embodiments, a mark space may be filled in wholly or partially by a mark. In some embodiments, the mark may be printed within mark space. For example, the mark may be any variety of shading, coloring, symbol, such as a check mark or “X”, or any other distinguishing element. In other embodiments, mark may be any other physical marking. For example, mark may be provided as a hole, tear, indentation, or any other physical alteration to label web contained within mark space. In some embodiments, the mark space may be a blank space, which may or may not be surrounded by a border to form a box or any other geometric shape or figure, and a mark may be applied to a heat transfer label area in this blank space as the designated area for the mark space.

As discussed herein, the at least one mark may take many forms. For example, mark may be applied by any suitable ink or other marking utensil as is known in the art. In some embodiments, mark may be printed within mark space in any form, such as the “X” illustrated in FIG. 2, using any suitable printing method, such as an ink-jet, laser, die cut, rotary die cut, thermal, or any other printing means known in the art. In some embodiments, mark is stamped within mark space. Any suitable type of ink may be used to apply mark, such as water-based inks, dry sublimation inks, solvent inks, UV cured inks, or any other inks known in the art. In one embodiment, the at least one mark is a water-mark not visible to the user, unless some other took is utilized such as a special light (i.e., a blue light, UV light, infrared light). In some embodiments, a system for manufacturing heat transfer labels may apply heat transfer material in lieu of ink in a mark space, allowing the mark space to be filled quickly and easily without requiring a separate apparatus be used for marking.

In other embodiments, mark may be applied with a punch/indentation, blade, or other physical tool to provide a hole, tear, indentation, or any other physical alteration to label web within mark space. Indicating that a heat transfer label has one or more defects by, for example, punching or cutting out a section of the heat transfer label area (i.e., within mark space), a system as contemplated in the present disclosure may advantageously make use of existing production hardware. For example, such a system may include a cutting blade. In some embodiments, mark may be any other physical alteration contained within mark space, such as any alteration that does not fully penetrate the label web. For example, laser etching may be used to indicate mark 208 within mark space.

In some embodiments, a mark may be an external object, such as a barcode sticker or RFID device, such as an RFID inlay or an RFID chip (not illustrated). An external object may be applied to defective heat transfer labels upon identification of those heat transfer labels as defective. For example, once a heat transfer label is identified as being defective, a barcode sticker may be applied to the heat transfer label. In some embodiments, a barcode sticker may be used to identify one or more properties of the defect or may otherwise be used to track the defect. Likewise, a RFID device may be applied in a sticker or using any suitable adhesive, and may encode the same information relating to properties of the defect. Other objects containing unique identification may likewise be added.

In one embodiment there may be more than one mark on a heat transfer label. The heat transfer label may have multiple markings indicating a variety of defects. The multiple markings may also communicate a variety of information to a user. Thus, each of the plurality of marks can correlate to different information available to the user. For example, a heat transfer label may have a first marking indicating a specific defect and a second marking indicating a method of procedure based on the first marking. In view of this embodiment, the heat transfer label may therefore also have multiple mark spaces where a mark may be placed.

In some exemplary embodiments, a marking system may be incorporate into a more traditional heat transfer label forming process, as well as into a roll-type heat transfer label forming process. For example, the heat transfer label areas may initially be contained in one or more rows or columns on a label web, and subsequently cut apart from one another and separated so that defective heat transfer labels may be removed prior to shipping or subsequent use.

Occasionally it may be desirable or acceptable to retain one, some, or all of the defective heat transfer labels contained on a label web. For example, an individual heat transfer label may have a plurality of elements, images, characters, letters, or any combination of the foregoing, formed thereupon, only one of which is defective, unusual, or unusable. For example, a heat transfer label may be formed so as to form the word “HI,” having the letters “H” and “I” next to one another in some predetermined font, sizing, style, and spacing. Such heat transfer labels may make it easy to apply the word “HI” on a garment undergoing mass production. In some instances, a heat transfer label may be found to be defective. For example, the H may be formed in a defective manner, while the I may be usable or otherwise acceptable. Thus it may be desirable to convert the usable portion of the heat transfer label into a single-letter heat transfer label (i.e., a heat transfer label having the letter “I” only). Advantageously, an end user may use such single-letter heat transfer labels in connection with other heat transfer labels, such as other letters to spell any word they want on a garment. In some embodiments, both defective and usable portions of a defective heat transfer label can be used together, or separately, along with other portions of one or more defective heat transfer labels to create unique and one-of-a-kind items. By utilizing all or a portion of a defective heat transfer label in this manner, waste can be produced, while at the same time a manufacturer can realize additional revenues by selling unique items.

In some embodiments, a heat transfer label area may be marked in a mark space when at least a portion of the heat transfer label is defective, and the defective heat transfer label may be separated and diverted at a later stage of the production process. A defective portion or portions of the heat transfer label may be removed. In some embodiments, these defective portions may be repurposed as discussed above. In other embodiments, only the non-defective, or otherwise acceptable portions of the defective heat transfer label may be retained. Thus, a heat transfer label area may comprise more than one mark space. The heat transfer label area may comprise a mark space corresponding to each element, image, character, or letter contained on the heat transfer label. Advantageously, this allows for the identification, for example by a user or sensor, of specific defective element(s), image(s), character(s) or letter(s) by a mark applied to the mark space.

According to some embodiments, marks may be applied in mark spaces located proximate to the heat transfer labels. However, in other exemplary embodiments, marks may be applied in mark spaces located more distant from the heat transfer labels. For example, a mark may be applied in a mark space to indicate that the next heat transfer label, rather than the current (or more proximate) heat transfer label, is defective. If multiple subsequent heat transfer labels are defective, for example, the following two heat transfer labels, a different mark may be applied to mark space. For example, a mark may indicate how many subsequent heat transfer labels are defective, and may simply be a number such as 1, 2, 3, and so forth, to indicate this value.

In some embodiments, a heat transfer label has more than one mark space. In some embodiments, each mark space represents a different category or criteria associated with a specific number of subsequent heat transfer labels. For example, a heat transfer label may have a plurality of mark spaces that each represent a different category, such as color quality, color accuracy, text clarity, and any other category as related to the production or printing of an acceptable heat transfer label. In some embodiments, a heat transfer label having more than one mark space may contain a mark in each of the mark spaces that represents information about subsequent or prior labels in the label web. Advantageously, this can allow a user or system to receive a summary of the label web from a single heat transfer label. Additionally, the mark spaces may also have individual identification. For example, identification of the mark space may be as simple as a number located within the proximity of the mark space. The identification of a given mark space may serve as a means to identify a specific heat transfer label within a label web.

In some embodiments, a label web may be applied to another material, such as, but not limited to a paper backing. In some embodiments, a mark may be applied to the other material, such as the paper backing. In other embodiments, a mark is not applied at all. Rather, a mark may already exist in a mark space, such as a position number of the specific heat transfer label or another indication of the position of the specific heat transfer label, for example, on label web, and defective heat transfer labels may be logged by position number. For example, a production apparatus may log that heat transfer labels #350, #351, and #352 in the label web roll are defective as part of the production run. This information may then be associated with the roll by, for example, being stamped on the outside of the roll or by whatever other method may be desired.

With reference to FIG. 2, a label web 200 may be provided for use with a production apparatus configured to analyze a set of heat transfer labels 204a, 204b, 204c contained within heat transfer label areas 202a, 202b, 202c, each having a corresponding mark 208a, 208b, 208c contained in a corresponding mark space 206a, 206b, 206c. With the embodiment shown in FIG. 2, a mark 208 is used to indicate that the heat transfer label 204 has passed inspection and is not defective, rather than indicating that the heat transfer label 204 is somehow defective.

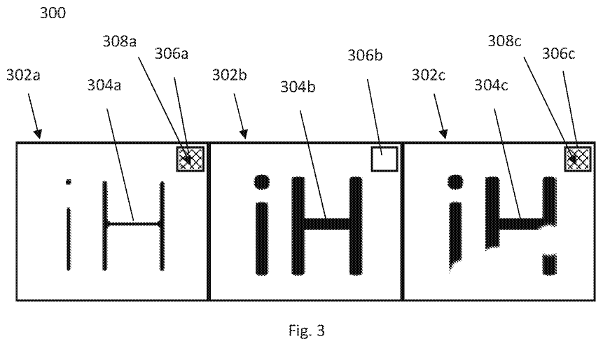

With reference to FIG. 3, an exemplary embodiment of a label web 300 containing heat transfer labels 304a, 304b, 304c having certain defects is shown. As shown, label web 300 may have a first heat transfer label 304a provided in a heat transfer label area 302a with a mark space 306a associated therewith. Label web 300 also may have a second heat transfer label 304b provided in a heat transfer label area 302b with a second mark space 306b associated therewith, and a third heat transfer label 304c provided in a heat transfer label area 302c with a third mark space 306c associated therewith.

As illustrated, first heat transfer label 304a and third heat transfer label 304c may each be defective and indicated as such. Specifically, the first heat transfer label 304a may have unacceptable variations in thickness, for example, being much thinner than a desired heat transfer label, while the third heat transfer label 304c may have a line of dead spots across a bottom portion thereof. As such, a first mark space 306a may be provided with a mark 308a indicating that the first heat transfer label 304a is defective. Likewise, a third mark space 306c may be provided with a mark 308c indicating that the third heat transfer label 304c is defective. In contrast, a mark is not provided in the second mark space 306b, thus indicating that the second heat transfer label 304b does not contain defects and is usable. In some exemplary embodiments, the nature or character of the defect may also be indicated.

According to some embodiments, a sensor station for use in the manufacture of goods containing heat transfer labels may be a heat bonder equipped with a sensor system. In some embodiments, sensor station may be a heat bonder equipped with an inspection station. Sensor stations contemplated by the present disclosure may be equipped with one or both of a sensor and a marking system, which may be used in the production of a label web. Other variations on a sensor station may also be contemplated to exist.

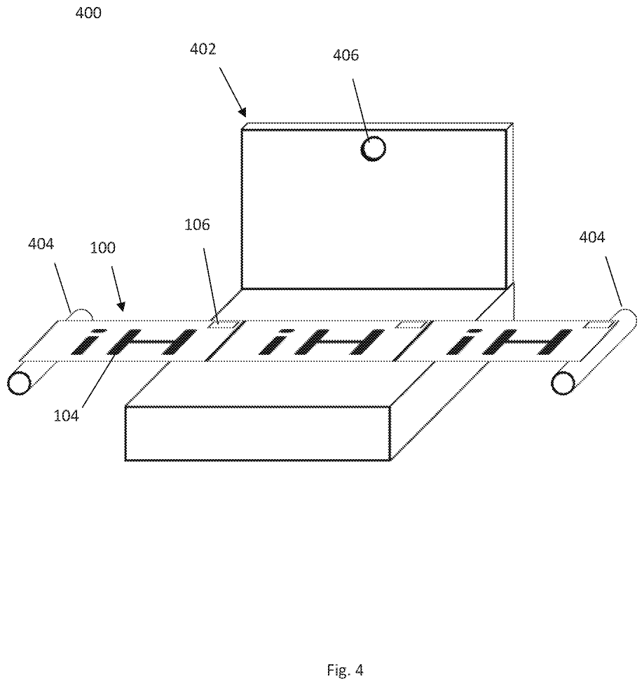

With reference to FIG. 4, an exemplary embodiment of a heat bonder system 400, which may function as a sensor station, is shown. According to an exemplary embodiment, a heat bonder 402 may be provided with a sensor 406. In some embodiments, sensor 406 may be used to detect the presence, or absence, of one or more marks contained in a mark space 106 on a label web 100. In some embodiments, heat bonder system 400 may have one or more rollers 404 used to advance a label web 100 through heat bonder system 400. According to some embodiments, sensor 406 first scans a label web 100 to determine if there are any marks contained in the mark space 106 of a given portion of the label web 100. If there are no marks indicating that a particular heat transfer label 104 is defective, the heat transfer label 104 may be combined with a garment and applied thereto.

If a mark is present in the mark space 106, indicating that the corresponding heat transfer label is defective, then, once the sensor 406 has detected the mark, the heat bonder system 400 may advance the label web 100 to the next heat transfer label. If the sensor 406 detects the presence of a mark in the mark space corresponding to the next heat transfer label, then the heat bonder system 400 may once again advance the label web 100 to the next heat transfer label. This process may be repeated as many times as necessary until the next good heat transfer label, such as a heat transfer label that meets a user's requirements, is advanced.

In some embodiments, a mark provided in a mark space may indicate how many defective heat transfer labels are between the current label and the next good heat transfer label. For example, label web 100 may contain three defective heat transfer labels in a row. In such embodiments where the mark indicates the number of defective heat transfer labels, the heat bonder system 400 may advance the label web 100 to a desired position more quickly than if sensor 406 were required to inspect the heat transfer label area of each defective heat transfer label to determine whether a mark was present in the corresponding mark space. In some embodiments, if the sensor 406 detects the presence of a mark, a visual and/or audio indicator may be triggered to provide additional feedback to a user and/or operator.

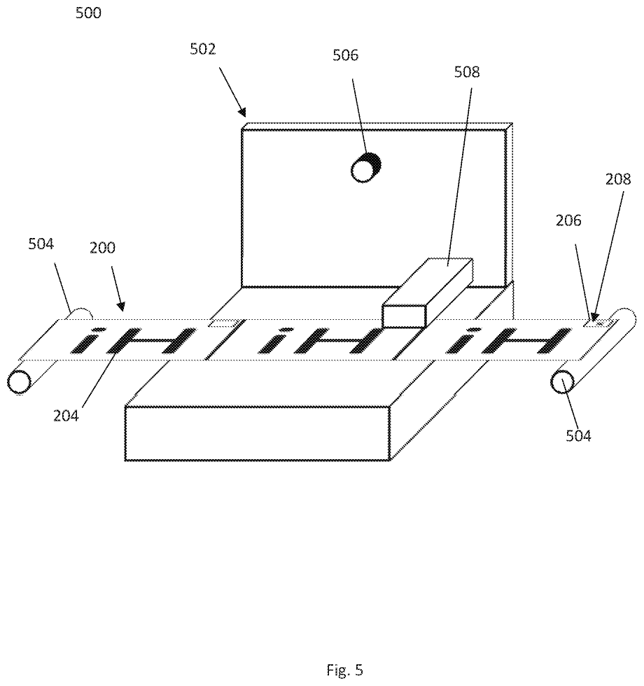

Turning next to FIG. 5, FIG. 5 shows an exemplary embodiment of a heat bonder system 500, which may function as an inspection station for quality assurance. In some embodiments, heat bonder station 500 may be used during a production process in order to detect whether or not heat transfer labels 206 on a label web 200 are defective. According to some embodiments, heat bonder system 500 may include a sensor stand 502, one or more rollers 504, a sensor 506, and a marking tool 508. The present invention contemplates that the sensor utilized may be any sensor known in the art, such as, but not limited to a heat, light and/or chemical sensor.

In some embodiments, label web 200 is provided with a series of heat transfer labels 204, each with a corresponding mark space 206. The sensor 506 may scan the heat transfer labels 204, such as each heat transfer label 204 in turn, to determine whether the heat transfer labels 204 have passed inspection, or if any heat transfer labels 204 are defective. The marking tool 508 may then be used to apply a mark 208 in the mark space 206 as disclosed herein. For example, in some embodiments, marking tool 508 applies a mark 208 if the heat transfer label 204 has passed inspection. In other embodiments, marking tool 508 applies a mark 208 if the heat transfer label 204 has failed inspection. In some embodiments, marking tool 508 may apply different marks, one to indicate passage, and one to indicate failure.

In some embodiments, marking tool 508 may comprise a printer, such as an ink-jet printer, a laser printer, a thermal printer, or any other type of printer known in the art. In some embodiments, marking tool 508 comprises a UV curing station when use of UV inks is contemplated. In some embodiments, marking tool 508 is configured to stamp a mark within mark space. In some embodiments, marking tool 508 is configured to apply heat transfer material in a mark space.

In other embodiments, marking tool 508 is configured to form a hole, tear, indentation, cut, or other physical alteration to label web within mark space. For example, marking tool 508 may be a punch/indentation, blade, or other physical tool. In still further embodiments, marking tool 508 may comprise a laser configured to etch a mark within mark space.

In some embodiments, the sensor 506 may record data, such as an image of each defective heat transfer label 204, or a position of each defective heat transfer label 204, in order to facilitate improvements to the production process. For example, a sensor 506 may determine how often a certain type of error or defect has occurred in the production process, and may communicate this information to a manufacturing control system (not illustrated) that may dynamically adjust the manufacturing process. For example, a manufacturing control system may slow down or stop, and optionally restart, the manufacturing process if an error rate is unacceptably high and/or if the errors encountered are of a type that are likely to be reduced in prevalence or severity by slowing down, stopping, and/or restarting the manufacturing process. Alternatively, any other mitigating steps may be taken either automatically or as specified by a user or administrator.

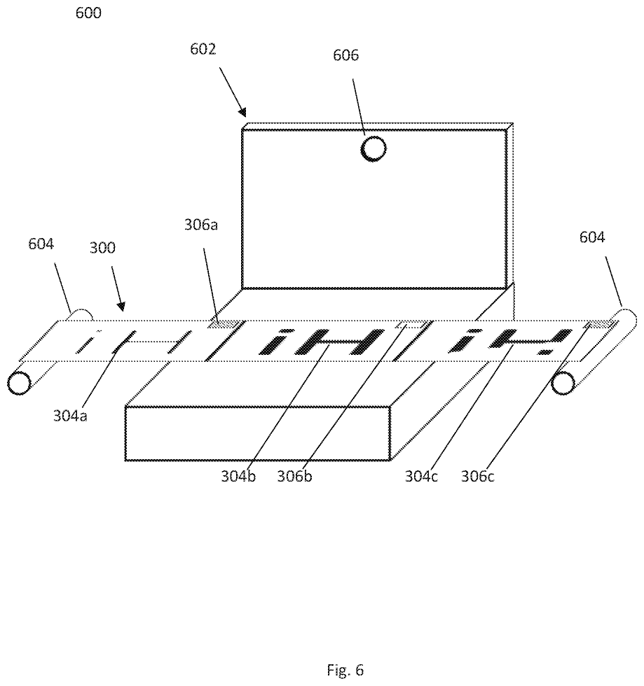

With reference to FIG. 6, an exemplary embodiment of a heat bonder system 600, which may function as a sensor station, is shown. According to some embodiments, a heat bonder 602 may be provided with a sensor 606. In some embodiments, sensor 606 may be used to detect one or more marks in one or more mark spaces of a label web 300. In some embodiments, heat bonder system 600 may have one or more rollers 604 that may be used to advance a label web 300, as discussed further elsewhere herein.

In some embodiments, a label web 300 may have one or more defective heat transfer labels, such as the first heat transfer label 306a and the third heat transfer label 304c. First and third heat transfer labels 304a, 304c may be indicated as being defective by the presence of a mark in the first mark space 306a and the third mark space 306c, respectively. As such, when the sensor 606 detects a mark, heat bonder system 600 may skip the defective heat transfer labels and move on to the next good heat transfer label.

As shown in FIG. 6, the second heat transfer label 304b is not defective, and as such the mark space 306b corresponding to the second heat transfer label 304b is not marked. Once the sensor 606 determines that the second heat transfer label 304b is acceptable, the heat bonder system 600 may instruct the heat bonder 602 to operate. This may entail, for example, placing an article, such as a garment, above the second heat transfer label 304b as it is disposed over the heat bonder 602, and closing the lid of the heat bonder 602 (which may be a surface on which the sensor 606 is disposed, or may be another surface) in order to apply heat to the article and the heat transfer label 304b to effect bonding of the heat transfer label 304b to the article in a desired position. Once the heat transfer label 304b has been applied, the lid of the heat bonder 600 may rise or otherwise open, and heat bonder system 600 may operate the rollers 604 to advance the label web 300 to the next good transfer. In some embodiments, as shown in FIG. 6, heat bonder system 600 may be required to operate rollers 604 to skip at least one defective heat transfer label before an acceptable heat transfer label is reached.

According to some embodiments, a heat bonder system 600 may also interpret other marks that have been applied to one or more mark spaces on label web 300. For example, a label web 300 may be provided with one or more marks to indicate how many heat transfer labels remain after the heat transfer label corresponding to a particular mark. In some embodiments, this information may be used to signal the heat bonder system 600 to stop advancing the rollers 604 when the rollers reach the end of the label web 300 roll. In some embodiments, a label web 300 may be provided with one or more marks at the start of the label web 300 roll, which may be separated from any heat transfer labels (if desired) and may provide one or more instructions about how to operate a heat bonder system 600 that has loaded a particular label web 300. For example, one or more marks may be provided that may cause the heat bonder system 600 to load a particular temperature profile or other such operating instructions. In another exemplary embodiment, one or more marks containing such information and/or additional information may be provided throughout the label web 300 roll. For example, in some embodiments, a first set of heat transfer labels and a second set of heat transfer labels may be provided on the same roll, and one or more marks may be used to indicate to the heat bonder system 600 each set of marks so that heat bonder system 600 may adjust any operating parameters as necessary.

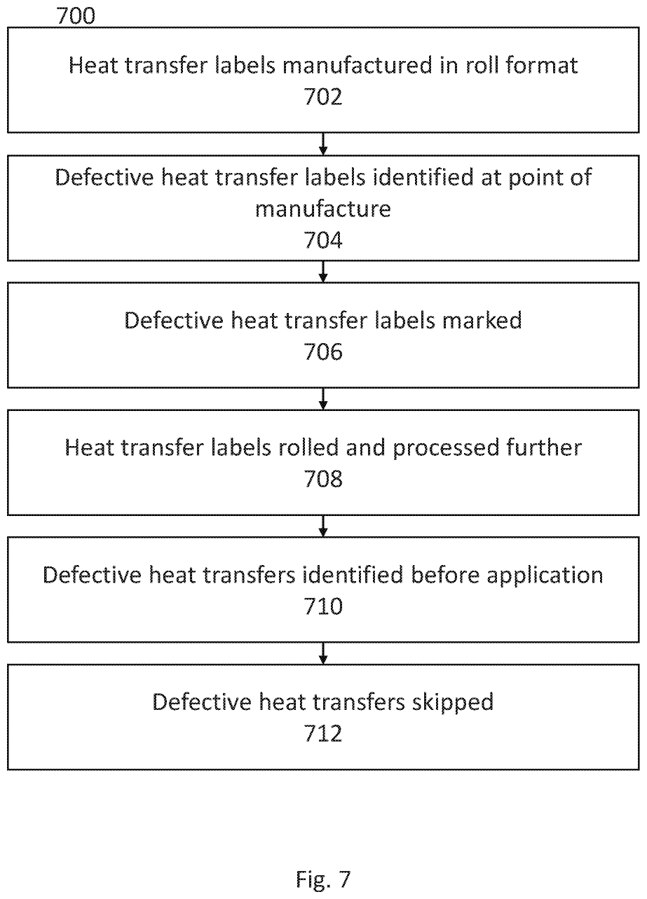

With reference to FIG. 7, a flowchart showing an exemplary embodiment of a method 700 of continuous processing of heat transfer labels is shown. As shown, a set of heat transfer labels may be manufactured in a roll format at 702. In some embodiments, the heat transfer labels may be kept as a roll after manufacturing. In other embodiments, individual heat transfer labels may be cut from the roll after manufacturing.

After heat transfer labels have been manufactured, one or more first sensors may scan the heat transfer labels on the web to identify defective heat transfer labels at the point of manufacture at step 704. In some embodiments, the one or more first sensors scan the heat transfer labels as the heat transfer labels are manufactured. In other embodiments, the one or more first sensors scan the heat transfer labels after the heat transfer labels are manufactured but before the web of heat transfer labels is fully wound into a roll.

Next, at 706, defective heat transfer labels may be marked in some fashion, as discussed herein. For example, a mark may be made next to each defective heat transfer label. Alternatively, a mark may be made next to each non-defective heat transfer label. In some embodiments, a serial number associated with a defective heat transfer label may be logged and stored. For example, a serial number and any other information, such as unique information pertaining to a given heat transfer label, may be stored in the any of the exemplary sensor stations disclosed herein. A person of ordinary skill in the art will understand that any alternative processes for distinguishing between defective heat transfer labels and acceptable heat transfer labels can also be used.

A web of heat transfer labels may then be assembled into a roll, and may be processed further as required or desired at 708. For example, a roll of heat transfer labels may be transported to a subsequent processing station or line, and may be installed on whatever production apparatus is using or will use the roll of heat transfer labels. In some embodiments, a roll of heat transfer labels may be shipped or transported to an end user, or may be stored for further processing at any future time.

According to some embodiments, the method may further include one or more quality assurance procedures. Such quality assurance procedures may be based around the provision of marks in mark space. For example, a roll of heat transfer labels with a number of defective heat transfer labels that exceeds a predetermined threshold may be thrown out, or may be sold at a lower price as being defect-heavy. For example, a roll of heat transfer labels containing 10% or more defective heat transfer labels, 25% or more defective heat transfer labels, 50% or more defective heat transfer labels, 75% or more defective heat transfer labels, or 90% or more defective heat transfer labels may be thrown out or sold at a discounted price.

Next, at 710, a roll of heat transfer labels may then be gradually unrolled in a system having at least one second sensor that can distinguish between marked and unmarked heat transfers, thus distinguishing between defective and acceptable heat transfer labels. In some embodiments, the at least one second sensor may be an optical sensor used to identify defective heat transfer labels before application. As illustrated, any defective heat transfer labels may be skipped at 712 For example, the at least one second sensor may detect a mark in mark space to determine that the corresponding heat transfer label is defective, and automatically advancing the roll to a later or subsequent heat transfer label. For example, the system may advance the roll to the next good heat transfer label. In some embodiments, the system may skip any number of subsequent defective heat transfer labels before advancing to an acceptable heat transfer label.

In some embodiments, the method and system may optionally incorporate the triggering of a visual device and/or audio device for additional feedback or intervention relating to defective heat transfer labels. For example, the visual device and/or audio device may be configured to display various colors and/or make various sounds representing non-marked heat transfers and display different various colors and/or make different various sounds representing marked heat transfers. In this manner, a user, administrator, or system is able to distinguish between acceptable heat transfer labels and defective heat transfer labels. In some embodiments, the visual device and audio device may be embodied within a single element, such as a chime strobe. In some embodiments, the triggering of a visual device and/or an audio device may occur prior to step 710. In a preferred embodiment, the triggering of a visual device and/or an audio device occurs during step 704. However, the system and method may also be configured to trigger the visual device and/or audio device after step 704.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method of processing heat transfer labels for quality assurance, comprising:
providing a carrier sheet comprising at least one heat transfer label contained in a heat transfer label area, the heat transfer label area comprising at least one mark space;
determining if the at least one heat transfer label is defective; and
marking the at least one heat transfer label if defective.

2. The method of claim 1, where the carrier sheet is provided in a roll and the at least one heat transfer label comprises a plurality of heat transfer labels.

3. The method of claim 1, where determining comprises scanning the at least one heat transfer label with a sensor.

4. The method of claim 1, further comprising performing quality assurance procedures.

5. The method of claim 1, further comprising identifying a defective heat transfer label with a sensor.

6. The method of claim 2, further comprising automatically advancing the roll from a defective heat transfer label to a later heat transfer label.

7. A system for processing heat transfer labels, comprising:
a carrier sheet comprising at least one heat transfer label contained in a heat transfer label area, the heat transfer label area comprising at least one mark space;
a first sensor;
a marking tool; and
a second sensor.

8. The system of claim 7, where the first sensor is configured to scan the at least one heat transfer label during manufacturing to determine if the at least one heat transfer label is defective.

9. The system of claim 7, where the second sensor is an optical sensor configured to identify defective heat transfer labels.

10. The system of claim 9, where the optical sensor is configured to identify a mark made on a defective heat transfer label.

11. The system of claim 7, where the carrier sheet is in a roll and the at least one heat transfer label comprises a plurality of heat transfer labels.

12. The system of claim 11, where the second sensor is configured to automatically advance the carrier sheet roll from a defective heat transfer label to a later heat transfer label.

13. The system of claim 7, further comprising one or both of a visual device for user feedback and an audio device for user feedback.

14. The system of claim 11, where the heat transfer label area has a plurality of mark spaces.

15. The system of claim 14, where each of the plurality of heat transfer labels has a corresponding mark space.

16. A sensor station apparatus, comprising:
a heat bonder comprising a sensor system;
at least one roller; and
a marking tool.

17. The sensor station apparatus of claim 16, where the sensor system comprises a sensor configured to scan heat transfer labels provided on a carrier web and determine if any heat transfer labels are defective.

18. The sensor station apparatus of claim 17, where the sensor is configured to advance the carrier web from a defective heat transfer label to a later heat transfer label.

19. The sensor station apparatus of claim 17, where the sensor is at least one of an optical, light, proximity, and/or infrared sensor.

20. The sensor station apparatus of claim 16, further comprising one or both of a visual device for user feedback and an audio device for user feedback.
